(19) United States
(12) Patent Application Publication
(10) Pub. No.: US 2009/0271450 A1
(43) Pub. Date: Oct. 29, 2009

(54) Collaborative Document Versioning

(75) Inventor: Christopher Leon Bush, Austin, TX (US)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/111,261

(22) Filed: Apr. 29, 2008

(51) Int. Cl. G06F 17/30

(52) U.S. Cl. 707/203; 707/E17.005

(57) ABSTRACT

A method, system, and computer usable program product for collaborative document versioning are provided in the illustrative embodiments. A document is received for versioning and stored in a data storage associated with a data processing system. A group of users is requested to collaborate in performing a pre-commit processing on the document. Based on the pre-commit processing, a determination is made if the document is to be versioned. The document is sent for versioning if the document is to be versioned.

### BACKGROUND OF THE INVENTION

1. Field of the Invention

The present invention relates generally to an improved data processing system, and in particular, to a computer implemented method for managing documents in a data processing system. Still more particularly, the present invention relates to a computer implemented method, system, and computer usable program code for collaborative document versioning.

2. Description of the Related Art

Users create many types of documents in a data processing system. For example, a user may create a text document for a user manual for a software application, a spreadsheet document for accounting, a source code document containing code for a software application, and many other types of documents.

Often, users create many versions of these documents. For example, a user may create a version of a user manual for one release of a software application, and another version for another release. Similarly, a user may create a version of a source code document to remedy one error in a software code and another version to remedy another error or add a new feature.

Additionally, users often work on documents in teams. A user in a team may be responsible for a document, a part of a document, or a set of documents. A set of documents may include one or more documents.

Generally, teams of users use one of many commercially available document management systems that are capable of managing several documents and their versions. These systems often also manage document related activities of several users, such as allowing a user to check out a document for modification, checking-in a modified document, and preventing other users from having access to a document while another user may be working on it.

A common usage of such system is in software development, where teams of users develop and manage many source code documents or files in order to create a cohesive software product. Users commonly refer to such document management systems as source code management system (SCM), code versioning system (CVS), source control and versioning system (SCV) and other permutations of similar words and phrases.

### SUMMARY OF THE INVENTION

The illustrative embodiments provide a method, system, and computer usable program product for collaborative document versioning. A document is received for versioning and stored in a data storage associated with a data processing system. A group of users is requested to collaborate in performing a pre-commit processing on the document. Based on the pre-commit processing, a determination is made if the document is to be versioned. The document is sent for versioning if the document is to be versioned.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a collaborative document management system in accordance with an illustrative embodiment;

FIG. 4 depicts a block diagram of a pre-versioning collaboration system in accordance with an illustrative embodiment;

FIG. 5 depicts a flowchart of a collaborative document versioning in accordance with an illustrative embodiment;

FIG. 6 depicts a flowchart of a process of closing pre-commit processing of a document in accordance with an illustrative embodiment; and

FIG. 7 depicts a flowchart of a process of determining whether to send a document for versioning in accordance with an illustrative embodiment.

### DETAILED DESCRIPTION OF THE PREFERRED EMBODIMENT

When a user modifies a document, a document management system may accept the modified document as a new version of an existing document, or a first version of a new document. The document management system may deliver a set of documents by delivering the latest versions of the documents in that set. For example, several thousand source code files, many of those files being at different versions, may together form a release of a software application. A document management system managing those files may deliver a set of those files at various versions to create a build for that release of the software application.

Illustrative embodiments recognize that a user's work in a team environment may affect the work of other users in the team. Illustrative embodiments also recognize that a user in a team may modify a document in a set of documents that may not be conducive to another modification or limitation elsewhere in the set of documents.

Furthermore, illustrative embodiments recognize that a user may modify a document in a manner that may not be acceptable to other users in the team. For example, a user may modify a code in a source code file that may remedy one error but create another error condition. A different user may be able to detect the new error condition and for that reason may not approve of the remedial code. As another example, a user may write code for a feature in an undesirable form, such as by using an amount of memory space that may degrade the performance of the overall software application. Another user, such as a team leader or a quality control tester, may object to the feature coded in this manner and may want to exclude the user's code from becoming a version in the document management system.

Present document management systems allow a user to check out a version of a document, modify the document, and check in the modified document as a different version. Illustrative embodiments recognize that the present document management systems operating in this manner allow users to create versions of documents that may include undesirable modifications. Illustrative embodiments further recognize that using the present document management systems, a user may create a version of a document that may not be acceptable by other users, may have to be reviewed by other users, or pass certain tests or criteria before being accepted as a version.

The illustrative embodiments recognize that allowing a user to create versions of document that may have to be withdrawn, reworked, or re-versioned is at least cumbersome. Present document management systems allow unusable versions to occupy storage space in the document management system and often require labor intensive cleanup process, which may sometimes result in erroneously purged usable versions.

To address these and other problems related to versioning documents, the illustrative embodiments provide a method, system, and computer usable program product for collaborative document versioning. The illustrative embodiments may be used in conjunction with any application or any data processing system that may use a document management system, including but not limited to presently available commercial document management systems.

For example, the illustrative embodiments may be implemented with a file system associated with an operating system. The illustrative embodiments may also be implemented with any business application, enterprise software, and middleware applications or platforms. Additionally, the illustrative embodiments may be implemented in conjunction with a hardware component, such as in firmware, as embedded software in a hardware device, or in any other suitable hardware or software form.

Any advantages listed herein are only examples and are not intended to be limiting on the illustrative embodiments. Additional advantages may be realized by specific illustrative embodiments. Furthermore, a particular illustrative embodiment may have some, all, or none of the advantages listed above.

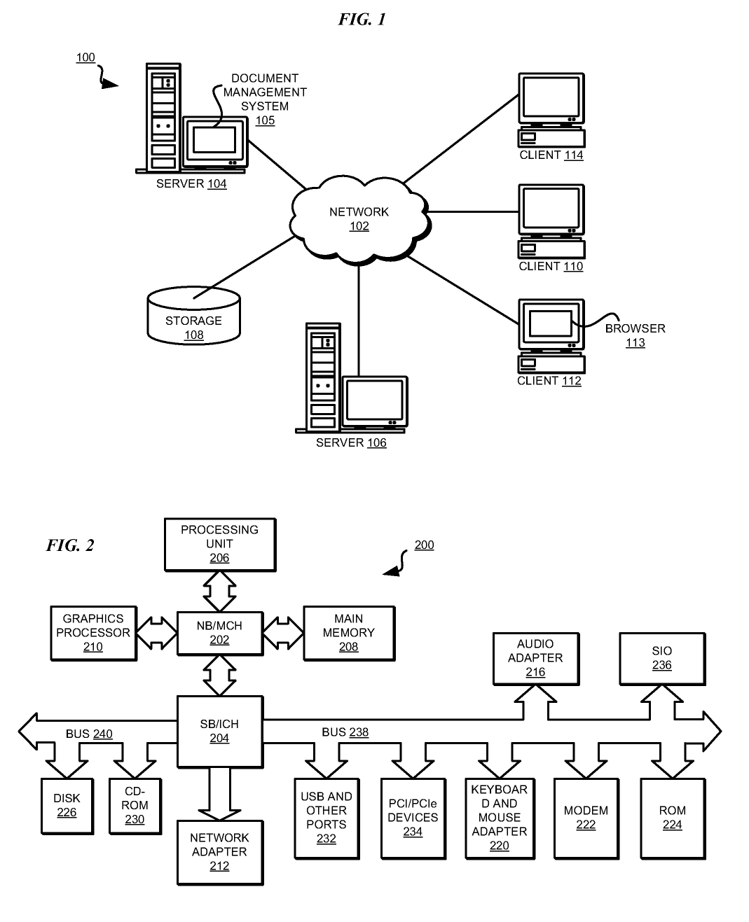

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108.

Software applications may execute on any computer in data processing environment 100. In the depicted example, server 104 includes document management system 105, which may be an example software application, in conjunction with which the illustrative embodiments may be implemented.

In addition, clients 110, 112, and 114 couple to network 102. Any of clients 110, 112, and 114 may have an application, typically a client application, executing thereon. As an example, client 112 is depicted to have browser 113 executing thereon. Browser 113 may be a commonly used web-browser.

Servers 104 and 106, storage units 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 provides data, such as boot files, operating system images, and applications to clients 110, 112, and 114. Clients 110, 112, and 114 are clients to server 104 in this example. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® XP (Microsoft and Windows are trademarks of Microsoft Corporation in the United States and other countries), or Linux® (Linux is the trademark of Linus Torvalds in the United States and other countries). An object oriented programming system, such as the Java programming system, may run in conjunction with the operating system and provides calls to the operating system from Java programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

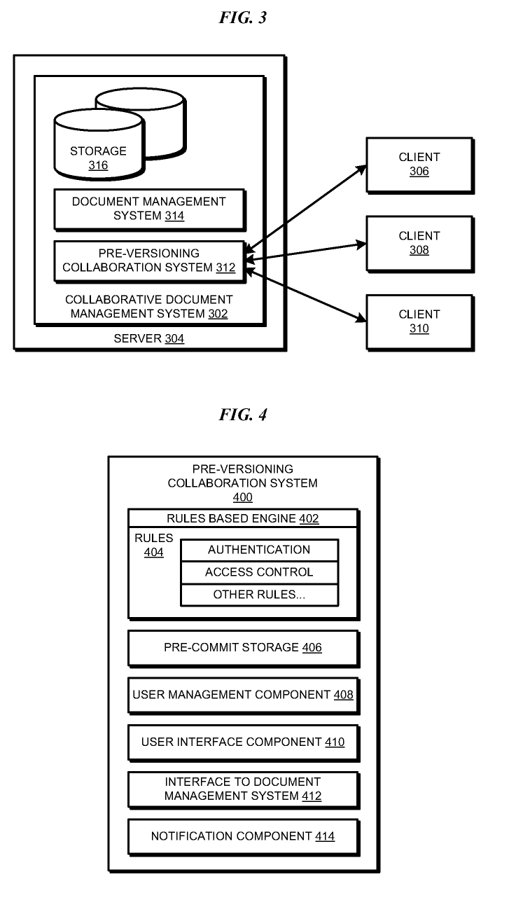

With reference to FIG. 3, this figure depicts a block diagram of a collaborative document management system in accordance with an illustrative embodiment. collaborative document management system 302 may be implemented using a document management system, such as document management system 105 in FIG. 1. Collaborative document management system 302 may execute in a data processing system, exemplarily depicted in FIG. 3 as server 304. Server 304, however, may be implemented using any of servers 104 or 106, or clients 110, 112, or 114 in FIG. 1.

Clients 306, 308, and 310 may each be any combination of software and hardware, such as a web browser or other application executing on a user's computer.

Collaborative document management system 302 includes pre-versioning collaboration system 312 and document management system 314. Collaborative document management system 302 may include storage 316 to store the documents and other data. Storage 316 may be associated with server 304 or may be accessible from server 304. Furthermore, storage 316 may itself be a combination of software and hardware, such as a database operating on a server, a file system on a hard disk, an index file, a flat file, or any other form suitable for storing data and managing documents.

A user using a client, such as any of clients 306, 308, or 310, may communicate with collaborative document management system 302 by interacting with pre-versioning collaboration system 312. Pre-versioning collaboration system 312 may be implemented as software, hardware, or a combination thereof, such as firmware. In one embodiment, pre-versioning collaboration system 312 may include a web server capable of serving web pages including fillable forms. A user may interact with pre-versioning collaboration system 312 via a web browser or other software for submitting a document for versioning. For example, a user may have modified a document that the user may wish to commit to document management system 314 as a new version of the document. The user may interact with pre-versioning collaboration system 312 for submitting that modified document.

Pre-versioning collaboration system 312 may take further actions before sending the document to document management system 314. For example, pre-versioning collaboration system 312 may notify other users in a team about the availability of a new document for review. Those users may also interact with pre-versioning collaboration system 312, such as for reviewing the document, commenting on the document, and rating the document or the modifications in the document.

Commenting on a document may include providing a comment separate from or within a given document. For example, a user may insert a comment in accordance with the illustrative embodiments in a comment area associated with a document. As another example, a user may add comments to the document itself. As another example, a user may comment on a document in accordance with the illustrative embodiments by associating another document with the document. As another example, a user may comment on a document by making an entry in a blog that may be associated with the document, a set of documents, a product, a user, or a team.

Rating a document may include giving an alphanumeric rating to a document, such as for indicting the quality of the modification in the document. As another example, rating a document may include selecting or modifying one or more graphical icons associated with the document. Rating may include rating and commenting.

These interactions with pre-versioning collaboration system 312 are only examples and not limiting on the illustrative embodiments. Many other interactions will be conceivable from this disclosure that may be used before a modified document is committed to document management system 314 as a new version. Pre-versioning collaboration system 312 is contemplated to facilitate all such interactions.

Any number of these and other similar interactions may be used on a given document. A set of such interactions is called pre-commit process. A set of such interactions is one or more such interactions. Using a set of such interactions in conjunction with pre-versioning collaboration system 312 is called pre-commit processing.

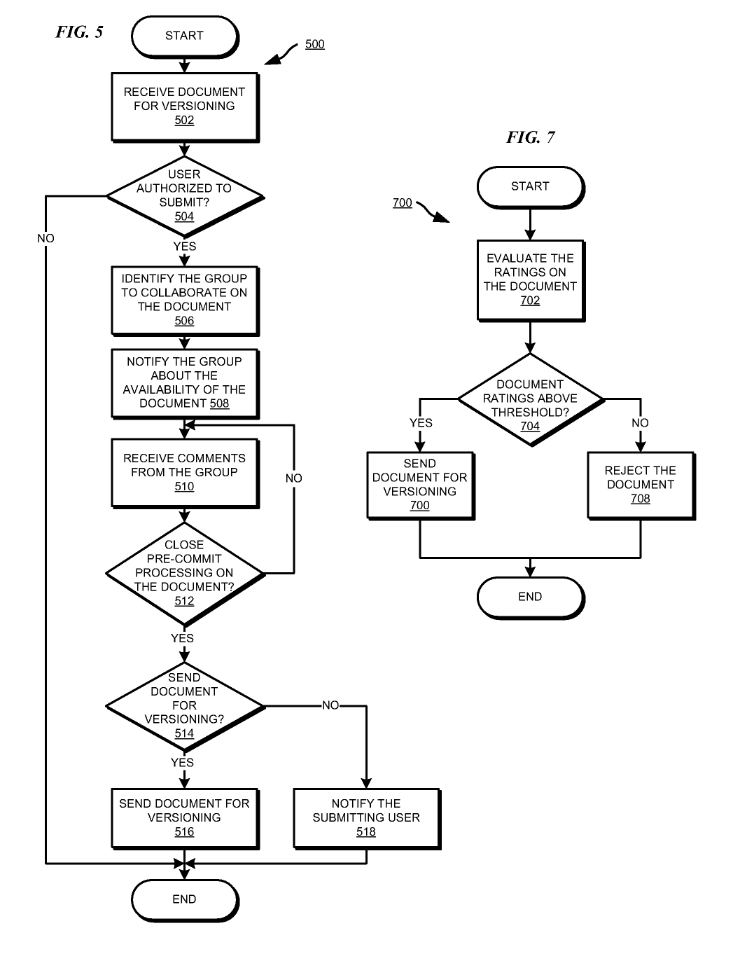

With reference to FIG. 4, this figure depicts a block diagram of a pre-versioning collaboration system in accordance with an illustrative embodiment. pre-versioning collaboration system 400 may be implemented as pre-versioning collaboration system 312 in FIG. 3.

FIG. 4 depicts pre-versioning collaboration system 400 with a set of example components that may facilitate the functions described here with respect to pre-versioning collaboration system 400. An embodiment of pre-versioning collaboration system 400 may include some, all, different, or additional components in pre-versioning collaboration system 400 for performing these and additional functions without departing from the scope of the illustrative embodiments.

Pre-versioning collaboration system 400 may include rules based engine 402. Rules based engine 402 executes rules 404, such as to perform certain functions, made certain decisions, or process certain inputs. Rules 404 may be stored anywhere such that pre-versioning collaboration system 400 can have access to them.

A rule in rules 404 may be code that implements logic, such that when rules based engine 402 executes the rule, rules based engine 402 can output a result that is expected from that logic. For example, rules 404 may include an authentication rule, which when executed may help rules based engine 402, and consequently pre-versioning collaboration system 400, determine whether a user wishing to interact with pre-versioning collaboration system 400 is a legitimate user. As another example, an access control rule in rules 404 may help determine whether an authenticated user has access to a particular document that the user may wish to retrieve from or commit to an associated document management system. These rules are described here only as examples and are not limiting on the illustrative embodiments. Many other rules will be conceivable from this disclosure and are contemplated within the scope of the illustrative embodiments.

Pre-versioning collaboration system 400 may also include pre-commit storage 406. When a user submits a modified document for versioning, pre-versioning collaboration system 400 may store such a document in pre-commit storage 406 until the pre-commit processing of that document is complete. Versioning is the process of creating a new version of a document.

Pre-versioning collaboration system 400 may further include user management component 408. User management component 408 may support functions for managing a user's collection go documents, such as a record of checked out documents, documents pending pre-commit processing, a dashboard view of the status of the various documents including comments and ratings received thereon. Many other user functions may be supported in a particular implementation of user management component 408.

Pre-versioning collaboration system 400 may include user interface component 410, which a user may interact with pre-versioning collaboration system 400. As in an example described above, one embodiment of user interface component 410 may be a web server. In another embodiment, user interface component 410 may present a command line interface for receiving user commands.

Pre-versioning collaboration system 400 may further include interface to document management system 412, which may facilitate communicating with one or more document management systems. For example, pre-versioning collaboration system 400 may use interface to document management system 412 to commit a document to a document management system when pre-commit processing of that document is complete. As another example, pre-versioning collaboration system 400 may use interface to document management system 412 to retrieve, and possibly lock, a document from the document management system when a user requests to check out that document. In a particular implementation, interface to document management system 412 may enable pre-versioning collaboration system 400 to execute all functions and interactions available with a given document management system.

Pre-versioning collaboration system 400 may include notification component 414 to notify users. For example, pre-versioning collaboration system 400 may use notification component 414 to notify other users when a user submits a document for versioning. Pre-versioning collaboration system 400 may also use notification component 414 to notify the user who submits a document about any pre-commit processing relating to that document. Notification component 414 may support any method of notification or communication without departing from the scope of the illustrative embodiment. For example, notification component 414 may provide notification service using email, phone, page, fax, bulletin board, blog entry, log entry, or any other suitable form of communication in a given implementation.

With reference to FIG. 5, this figure depicts a flowchart of a collaborative document versioning in accordance with an illustrative embodiment. Process 500 may be implemented in pre-versioning collaboration system 400 in FIG. 4.

Process 500 begins receiving a document for versioning (step 502). Process 500 determines if the user submitting the document is authorized to submit the document (step 504). Step 504 may include authenticating the user, verifying the user's access privileges, verifying the nature of the document, and any other verification used in a particular implementation.

If process 500 determines that the user is not authorized to submit the document (“No” Path of step 504), process 500 ends. If, however, process 500 determines that the user is authorized to submit the document (“Yes” Path of step 504), process 500 identifies the group of users who may be collaborating on the document received in step 502. For example, a team may be designated to review a set of documents. If the submitted document is a document in that set of documents, process 500 may identify that team as the group in step 506.

Process 500 may notify the group identified in step 506 (step 508). Such a notification may be by any method of communication and may include any amount of information. For example, process 500 may notify the members of the group by email, including the name of the document, identification of the user who submitted the document, date and time of submission, product with which the document may be associated, or any combination of this and other information.

Process 500 engages in pre-commit processing of the document. Process 500 may receive comments from the members of the group (step 510). Step 510 may include any pre-commit processing used in a particular implementation. For example, in one embodiment, step 510 may include receiving comments and ratings. In another example, step 510 may include receiving comments from some members of the group and receiving ratings or other input from other members of the group.

In another embodiment, step 510 may include receiving modifications to the document. For example, in such an embodiment, as a way of commenting, a member of the group may modify an original piece of code contained in the document with alternative code that the member may believe to be better in some respect to the original code in the document. Several members may similarly modify different pieces of code in the document or modify each other's suggested alternative code as a way of providing comments or ratings. Additionally, some members may modify the contents of the document, some members may further modify the modified contents of other members, and some members may comment in other manner described here.

In one implementation, the user who submitted the document may maintain final control on whether a suggested alternative or modification is acceptable or not. In another implementation, a member of the group, such as a team leader, may determine whether to accept a suggested modification to the document before the document is versioned. Many other variations and combinations of commenting, suggesting, modifying, rating, and altering by various members of a reviewing group will be conceivable from this disclosure and are contemplated within the scope of the illustrative embodiments.

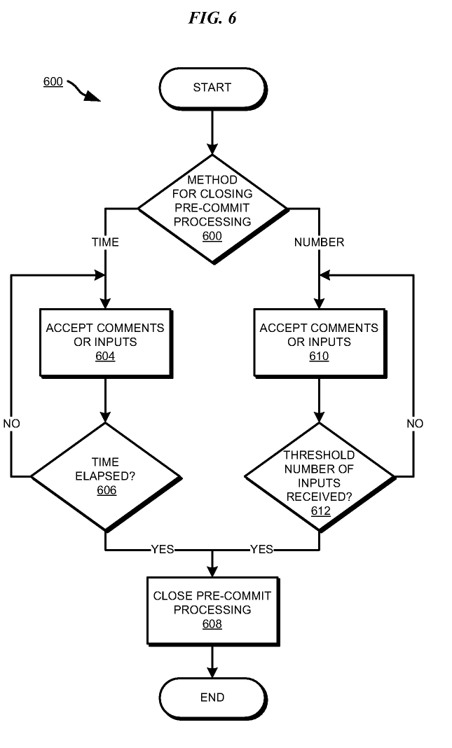

Returning to process 500, process 500 determines if the pre-commit processing of the document should be closed (step 512). Some examples of alternative ways for making the determination of step 512 are described with respect to FIG. 6. If process 500 determines that pre-commit processing of the document should continue (“No” path of step 512), process 500 returns to step 510. If process 500 determines that pre-commit processing of the document should be closed, such as when the pre-commit processing is complete, (“No” path of step 512), process 500 determines if the document should be sent for versioning (step 514).

If process 500 determines that the document should be sent to a document management system for versioning (“Yes” path of step 514), process 500 sends the document to an associated document management system (step 516). Process 500 ends thereafter.

If process 500 determines that the document should not be sent to a document management system for versioning (“No” path of step 514), process 500 may notify the submitting user about the decision not to commit the document for versioning (step 518). Process 500 ends thereafter.

Process 500 may determine that the document should not be sent for versioning, for example, when process 500 determines that a user in the group identified in step 506 has indicated that the document should not be versioned. As another example, an integrity check on the document may reveal that the document is corrupted, infected, or otherwise unsuitable for committing to a document management system, and process 500 may determine not to send the document for versioning in step 514. Additional reasons for not versioning a document will become apparent from this disclosure and the same are contemplated within the scope of the illustrative embodiments. Another reason for rejecting a document is described with respect to FIG. 7 below.

With reference to FIG. 6, this figure depicts a flowchart of a process of closing pre-commit processing of a document in accordance with an illustrative embodiment. Process 600 may be implemented as step 512 in FIG. 5.

Process 600 begins by determining a method for closing the pre-commit processing of a document (step 602). A particular implementation may select from any number of methods for determining if the pre-commit processing of a document should be closed. For example, as in FIG. 6, pre-commit processing may be closed when a certain number of comments have been received, or when a certain period has elapsed, or if a reviewer of the document has indicated to end the pre-commit processing. Pre-commit processing may also end if such processing becomes moot. For example, when the document being collaboratively reviewed is deleted from the system, or when the set of documents to which the document being collaboratively reviewed belongs are purged or removed, the pre-commit processing of the document may end. FIG. 6 depicts time and amount based decision in step 602 only as examples, and an implementation may use any decision criterion in step 602 without departing from the scope of the illustrative embodiments.

If process 600 determines that the method for closing pre-commit processing is time-based (“Time” path of step 602), process 600 may accept comments for a predetermined period of time (step 604). A particular embodiment may accept a different input for a different pre-commit processing in step 604 instead of accepting comments.

Process 600 may determine whether the predetermined period has elapsed (step 606). If process 600 determines that the predetermined time period has not elapsed (“No” path of step 606), process 600 returns to step 606 to keep pre-commit processing open for the document for more time. If process 600 determines that the predetermined time period has elapsed (“Yes” path of step 606), process 600 closes pre-commit processing of the document (step 608). Process 600 ends thereafter.

Returning to step 602, if process 600 uses a number based method for closing pre-commit processing on the document (“Number” path of step 602), process 600 accepts comments or other pre-commit processing inputs (step 610). For example, instead of comments, an embodiment may accept ratings in step 610.

Process 600 may determine whether the predetermined number of comments or inputs have been received (step 612). If process 600 determines that the predetermined number of inputs have not been received (“No” path of step 612), process 600 returns to step 610 to keep pre-commit processing open for the document for more inputs. If process 600 determines that the predetermined number of inputs have been received (“Yes” path of step 612), process 600 closes pre-commit processing of the document (step 608). Process 600 ends thereafter.

With reference to FIG. 7, this figure depicts a flowchart of a process of determining whether to send a document for versioning in accordance with an illustrative embodiment. Process 700 may be implemented as step 514 in FIG. 5.

Process 700 depicts an example method for making the determination whether to send a document for versioning. The method of deciding based on ratings has been chosen for clarity of the description and is not limiting on the illustrative embodiments. Many other methods for making a similar determination will become apparent from this disclosure and the same are contemplated within the scope of the illustrative embodiments.

Process 700 begins by evaluating the ratings a document that is being pre-commit processed has received (step 702). An implementation may perform step 702, for example, by aggregating and normalizing all the ratings the document receives.

Process 700 determines if the ratings evaluated in step 702 are above a threshold (step 704). For example, if an overall scale of ratings a document can receive ranges from 0-5, an implementation may set a threshold value of “4” for a document to get approval for versioning. In such an example implementation, if the normalized value of all ratings is above this threshold the document may be versioned, otherwise not. The range 0-5, and the threshold value “4” are only examples and not intended to be limiting on the illustrative embodiments. An implementation may select any range for a ratings scale, and any threshold value for ratings on a document for determining whether to version the document, without departing from the scope of the illustrative embodiments.

Continuing with process 700, if process 700 determines that the ratings of the document are above the threshold (“Yes” path of step 704), process 700 may send the document to an associated document management system for versioning (step 706). Process 700 ends thereafter. If, however, process 700 determines that the ratings of the document are not above the threshold (“No” path of step 704), process 700 may reject the document (step 708). Process 700 ends thereafter. In one embodiment, step 708 may conditionally send the document to the document management system for versioning, and perform other steps to manage that document as needed.

The components in the block diagrams and the steps in the flowcharts described above are described only as examples. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments for collaborative document versioning. By implementing the illustrative embodiments, users may be able to collaborate on a modified document before the modified document is versioned in a document management system. Users may be able to provide comments, rate a modification, further modify the modified document, or become aware of the modification so as to relate the modification to other changes elsewhere.

Through such collaboration, the users may be able to prevent unacceptable modifications to documents from being versioned in the document management system. The feedback provided through such collaboration may result in improving the quality of the documents, saving space in the document management system, and reducing document management system cleanup efforts.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for collaborative document versioning, the method comprising:
receiving a document for versioning;
storing the document in a data storage associated with a data processing system;
requesting a plurality of users to collaborate in performing a pre-commit processing on the document;
determining based on the pre-commit processing whether the document is to be versioned; and
sending the document for versioning in response to determining that the document is to be versioned.

2. The computer implemented method of claim 1, wherein the pre-commit processing is one of commenting on the document and rating the document.

3. The computer implemented method of claim 2, wherein the commenting further comprises:
inserting a comment in the document, wherein the comment indicates for a portion of the document one of (i) a suggestion and (ii) a replacement, and wherein the comment is manipulated in the document by a sender of the document before the document is versioned.

4. The computer implemented method of claim 1, further comprising:
determining, forming a closing determination, whether at least one of (i) a number of comments received is above a threshold value and (ii) a period of time has elapsed since receiving the document; and
closing the pre-commit processing responsive to the closing determination being true.

5. The computer implemented method of claim 1, further comprising:
determining whether a user from whom the document is received is authorized to send the document; and
rejecting the document in response to the user not being authorized to send the document, and accepting the document in response to the user being authorized to send the document.

6. The computer implemented method of claim 1, further comprising:
notifying the plurality of users about receiving the document.

7. The computer implemented method of claim 1, further comprising:
notifying a sender of the document if the document is rejected to be versioned based on the pre-commit processing.

8. A computer usable program product comprising a computer usable medium including computer usable code for collaborative document versioning, the computer usable code comprising:
computer usable code for receiving a document for versioning;
computer usable code for storing the document in a data storage associated with a data processing system;
computer usable code for requesting a plurality of users to collaborate in performing a pre-commit processing on the document;
computer usable code for determining based on the pre-commit processing whether the document is to be versioned; and
computer usable code for sending the document for versioning in response to determining that the document is to be versioned.

9. The computer usable program product of claim 8, wherein the pre-commit processing is executing one of computer usable code for commenting on the document and computer usable code for rating the document.

10. The computer usable program product of claim 9, wherein the computer usable code for commenting further comprises:
computer usable code for inserting a comment in the document, wherein the comment indicates for a portion of the document one of (i) a suggestion and (ii) a replacement, and wherein the comment is manipulated in the document by a sender of the document before the document is versioned.

11. The computer usable program product of claim 8, further comprising:
computer usable code for determining, forming a closing determination, whether at least one of (i) a number of comments received is above a threshold value and (ii) a period of time has elapsed since receiving the document; and
Computer usable code for closing the pre-commit processing responsive to the closing determination being true.

12. The computer usable program product of claim 8, further comprising:
computer usable code for determining whether a user from whom the document is received is authorized to send the document; and
computer usable code for rejecting the document in response to the user not being authorized to send the document, and computer usable code for accepting the document in response to the user being authorized to send the document.

13. The computer usable program product of claim 8, further comprising:
computer usable code for notifying the plurality of users about receiving the document.

14. The computer usable program product of claim 8, further comprising:
computer usable code for notifying a sender of the document if the document is rejected to be versioned based on the pre-commit processing.

15. A data processing system for collaborative document versioning, the data processing system comprising:
a storage device, wherein the storage device stores computer usable program code; and
a processor, wherein the processor executes the computer usable program code, and wherein the computer usable program code comprises:
computer usable code for receiving a document for versioning;
computer usable code for storing the document in a data storage associated with a data processing system;
computer usable code for requesting a plurality of users to collaborate in performing a pre-commit processing on the document;
computer usable code for determining based on the pre-commit processing whether the document is to be versioned; and
computer usable code for sending the document for versioning in response to determining that the document is to be versioned.

16. The data processing system of claim 15, wherein the pre-commit processing is one of commenting on the document and rating the document.

17. The data processing system of claim 15, further comprising:
computer usable code for determining, forming a closing determination, whether at least one of (i) a number of comments received is above a threshold value and (ii) a period of time has elapsed since receiving the document; and
computer usable code for closing the pre-commit processing responsive to the closing determination being true.

18. The data processing system of claim 15, further comprising:
computer usable code for determining whether a user from whom the document is received is authorized to send the document; and
computer usable code for rejecting the document in response to the user not being authorized to send the document, and computer usable code for accepting the document in response to the user being authorized to send the document.

19. The data processing system of claim 15, further comprising:
computer usable code for notifying the plurality of users about receiving the document.

20. The data processing system of claim 15, further comprising:
computer usable code for notifying a sender of the document if the document is rejected to be versioned based on the pre-commit processing.
